(19) United States
(12) Patent Application Publication
(10) Pub. No.: US 2007/0102325 A1
(43) Pub. Date: May 10, 2007

(54) Device for sorting different materials with the aid of a conveyor belt and an electromagnetic actuator

(76) Inventors: Hans Boffo, Main (DE); Alexander Hofmann, Main (DE)

Correspondence Address: MILDE & HOFFBERG, LLP, 10 BANK STREET, SUITE 460, WHITE PLAINS, NY, 10606, US

(21) Appl. No.: 10/579,601

(22) PCT Filed: Nov. 18, 2004
(86) PCT No.: PCT/EP04/13108

§ 371 Date: May 17, 2006

(30) Foreign Application Priority Data
Nov. 21, 2003 (DE) 103 54 777.0

(51) Int. Cl. B07C 5/00

(52) U.S. Cl. 209/225; 209/552; 209/652

(57) ABSTRACT

A device for sorting different materials comprises a conveyor belt (30), at least one sensor (37) that is allocated to the conveyor belt (30) and detects pieces of material according to the location thereof on the conveyor belt (30), and at least one actuator (24) which separates pieces of material in accordance with signals of the sensor(s) (37). The sorting device has an electromagnetic actuator (24) which includes an ejecting part (15) that is rotatable about a shaft (7) and is connected to at least one coil (10). The coil (10) is located in the air gap between two pairs, oppositely poled permanent magnets (8, 9, 22) and can be rotated from a zero position between the first oppositely magnetized pair (8) into a second position between the second oppositely magnetized pair (9). A rotational movement of the coil (10) causes the ejecting part (15) to separate the respective pieces of material.

The present invention relates to a device for sorting different materials, the device comprising a conveyor belt and at least one sensor which is assigned to the conveyor belt and senses pieces of material in a location-dependent manner on the conveyor belt, and at least one actuator which sorts out pieces of material in accordance with signals of the at least one sensor in a location-dependent manner.

Environmental requirements, but also the demand for saving natural resources of raw materials, have the effect that reusable materials from waste products are recycled. Particularly valuable are here metals which after having been sorted out of the waste are reprocessed as raw materials or allocated or added to new raw materials. Of particular importance in this recycling process is the separation of different steels and residual metals according to their types because only pure basic materials constitute valuable basic materials for recycling.

Since the waste amounts to be recycled are more and more increasing, sorting devices that sort the waste products, also domestic waste, have been used for several years. Apart from plastics, a particularly valuable fraction is represented by the metals that, after having been separated, must be sorted according to their type.

Such systems for recycling reusable materials are used in a harsh environment, so that metal pieces were sorted in the past by using compressed-air devices. Such sorting devices usually comprise a conveying trough from which the comminuted metal pieces are discharged as pre-sorted bulk material onto a conveyor belt. The individual pieces of metal, distributed over the width of the conveyor belt, are then passed over a field of metal sensors, normally of an inductive type. A nozzle field comprising individual nozzles from which air can be ejected is positioned at the outlet side of the conveyor belt. In response to signals output by the individual metal sensors during sensing of a metal part on the conveyor belt, the respective compressed-air nozzles which correspond to this position of the metal part are actuated to change the flight path of the metal parts discharged from the conveyor belt in such a manner that they are separated from the rest of the metal parts. Such systems have advantages and disadvantages during use. Disadvantages are the complicated compressed-air supply to the nozzle field, the inaccurate separation of lightweight materials, such as foamed materials, due to the influence of neighboring sorting materials, and an inaccurate separation due to the geometrical shape of the sorting materials.

Starting from the above-described prior art, it is now the object of the present invention to provide a device for sorting different materials, particularly recyclable materials, which avoids the drawbacks of the above-described prior art and is particularly simple in its structure, shows high efficiency and particularly avoids complicated supply devices, such as compressed-air supply means.

This object is achieved by a sorting device comprising the above-mentioned features, which is characterized in that an electromagnetic actuator is used, comprising at least one energizable coil rotatably suspended about a shaft, the coil, starting from a basic position, performing a rotational movement about the shaft in the gap between a pair of first oppositely magnetized permanent magnets to a second position in a gap between a pair of second oppositely magnetized permanent magnets, comprising a magnetic field which in the gap of the second permanent magnets extends opposite to the direction of the magnetic field in the gap of the first permanent magnets, the rotational movement of the coil effecting an actuating operation for sorting out the piece of material.

In one embodiment, the at least one electromagnetic actuator is arranged at the side of the conveyor belt.

Preferably, the at least one actuator is driven in a location-dependent manner so as to pivot an ejector connected to the actuator into the transportation path of the correspondingly sensed piece of material for sorting out the piece of material.

In a further embodiment, the at least one electromagnetic actuator is arranged behind the end of the conveyor belt at the outlet side, and the ejector is pivotable into the flight path of the correspondingly sensed piece of material.

A particular embodiment provides a device for sorting different recyclable materials, the sorting device comprising a conveyor belt and a sensor field assigned to the conveyor belt, the sensor field sensing materials in a location-dependent manner on the conveyor belt, and comprising a modular unit which is arranged behind the end of the conveyor belt at the outlet side and which in accordance with signals of the sensor field drives corresponding actuators of the modular unit in a location-dependent manner to pivot an ejector connected to the respective actuator into the flight path of the correspondingly sensed piece of material.

The sorting device is distinguished by the electromagnetic actuator which on the one hand is of a simple construction and with which on the other hand comparatively great actuating forces can be accomplished. Moreover, such an electromagnetic actuator offers the possibility of achieving a small construction, the width of the actuator being substantially predetermined by the thickness of the permanent magnets and the thickness of the coil, in addition to an exterior housing. With such a small construction it is possible to assemble a plurality of such actuators into a modular unit in a compact way, so that a field of actuators can be accomplished. In such a modular unit it is then possible to exchange individual actuators if an incorrectly operating unit must be repaired. With such a construction the electric supply lines must only be separated from the actuator and reconnected to the new actuator. Such an exchange of an actuator can also be performed by operating and maintenance personnel having standard expertise. That is why such an electromagnetic actuator, but also a whole modular unit composed of a plurality of such actuators, can especially be used for sorting devices for sorting different recyclable materials, i.e. in a harsh environment. During use such a sorting device could particularly be tested for sorting metal parts and it achieved good results. It should be mentioned as a particular advantage in such sorting devices comprising said electromagnetic actuators that no complicated compressed-air supply means are needed. As a result, the sorting device is extremely mobile and can be used at any desired place, and it is only the electrical supply that must be ensured, which supply is needed at any rate for driving the conveyor belt. The advantages reside above all in the separation speed of up to 30 Hz (depending on type, adjusting angle and type of the parts, in the adaptation of the geometrical shape of the actuator to the grain size of the sorting materials), and in the possibility of adapting the arrangement to different conditions of use in an easy way.

In the above-indicated actuator, the windings of the coil extend in planes which are substantially positioned perpendicular to the shaft or axis.

Preferably, permanent magnets made from neodymium-iron boron are used. These permanent magnets have the advantage that they possess the highest energy density of all magnetic materials. To maintain high efficiency, the permanent magnets are formed as plate-like ring segments.

These ring segments, whose inner and outer radii have their origin at the shaft from which the coil is suspended, are thereby adapted to the rotational movement of the coil. In connection with these permanent magnets formed as ring segments, the coil is configured such that it comprises two legs which are radially oriented relative to the shaft. This has the effect that the windings are located almost perpendicular to the static field of the permanent magnets. This yields maximum efficiency with respect to the achievable force action.

The two sections of the coil that interconnect said legs are positioned relative to the ring segment-shaped permanent magnets such that they are substantially located outside the main magnetic field of the permanent magnets so that the influence of said sections of the coil is kept small in a current flow.

For a simple construction the coil is held on a carrier which is suspended from the shaft, the end of the carrier opposite to the coil forming an adjusting member. Said adjusting member may then be connected to further elements that are adapted to the respective requirements made on the electromagnetic actuator. In connection with sorting devices, as are also the subject of this description, the carrier has secured thereto a plate element that forms an impact member under movement of the coil and thus under movement of the carrier.

For the housing structure of the electromagnetic actuator the respective permanent magnets are held at the one side and at the other side of the gap on a respective base plate. In each of said base plates a bearing may be provided. In these bearings the shaft is held about which the carrier and thus the coil pivot.

A special problem is the power supply to the coil in view of the fact that the coil in its actuating processes performs a movement from the basic position into an operative position and then back into the basic position. Hence, sliding contacts would be advisable. These, however, represent a complicated construction, are subject to wear and increase friction. As a consequence, in a preferred variant of the electromagnetic actuator, the coil is supplied with-current by means of silicone-coated stranded wires. Such a stranded wire may be arranged at each side of the carrier and connected to the housing structure. In tests such silicone-coated stranded wires withstood up to 1 million movement cycles without breaking and thus without disabling the electromagnetic actuator. However, attention should be paid during use of such stranded wires that the contact and soldering points on the coil and thus at the housing side are subjected to small loads only, which means that the stranded wires should be laid in an adequately large loop, so that the movement of the stranded wire is limited to said loop portion. Therefore, the respective stranded wire or the loop should have a length several times the direct connection path between a connection point on the coil and a connection point at the housing side.

The above-mentioned base plates on which the respective permanent magnets are held are preferably spaced apart by a housing wall which encloses the coil and the permanent magnets.

To be able to provide an electromagnetic actuator that can assume three different positions so as to perform a setting or actuating operation, apart from a basic position, to two further positions, at least one further pair of third permanent magnets of opposite pole with respect to the pair of second permanent magnets is provided with a gap thereinbetween. Moreover, a further coil is provided and the further coil is offset relative to the first coil such that it is closer to the pair of third permanent magnets and will then be energized if a rotational movement takes place from the pair of second permanent magnets to the pair of third permanent magnets because the second coil is positioned closer to the pair of second permanent magnets. To return the arrangement again from the second position into the first position, the other coil that is closer to the pair of second permanent magnets is energized, whereas no current flows through the other coil. It is possible by means of the two coils to perform the respective adjusting operations. With such an arrangement comprising two coils that are selectively energized, the individual positions between the pairs of permanent magnets can be reached.

These respective positions of the coils between the respective pairs of permanent magnets can be used for a setting or actuating operation. This arrangement, which includes the two coils offset relative to one another, can be extended by further pairs of permanent magnets because an adjusting operation can be performed through the offset position of the coils between neighboring permanent magnet pairs.

For specific applications it is preferred that the permanent magnets cover a sector of about 90°.

For other applications in which three pairs of permanent magnets are provided, the sector may be between 120° and 180°.

As a rule, the coil is also acted upon in the basic position with negative or positive voltage and the polarity thereof is reversed for transfer from the basic position into the second position. The polarity is again reversed to return the coil from the second position into the basic position.

Thanks to the compact construction these actuators are particularly suited for building up modular units having a plurality of electromagnetic actuators arranged side by side. The shafts from which the coils are suspended are here preferably oriented along a line. To be able to accommodate further electromagnetic actuators in a modular unit per length unit, the shafts may also be offset relative to one another, so that first and second actuators, for instance, are each arranged to lie with their axes along a first line and a second line.

Further details and features of the invention become apparent from the following description of embodiments with reference to the drawings, in which

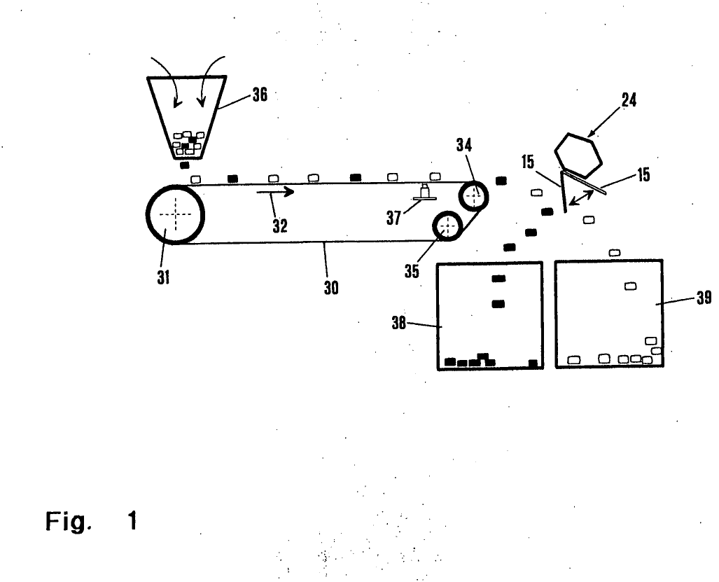

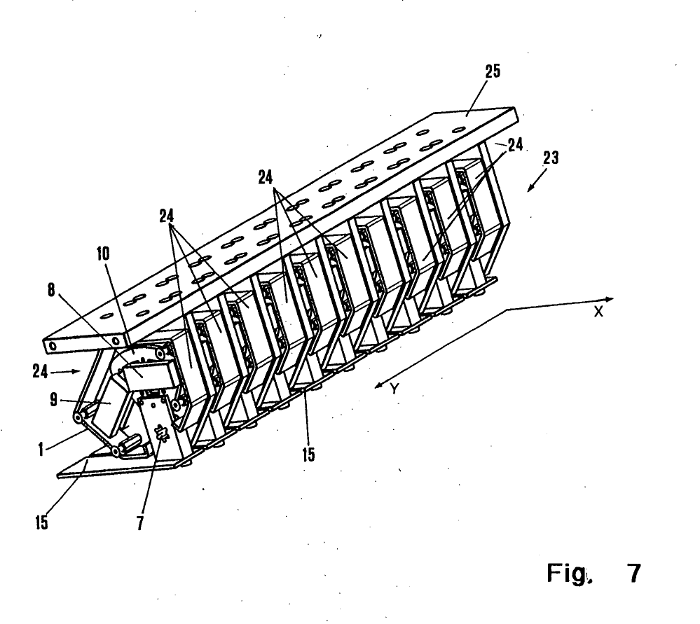

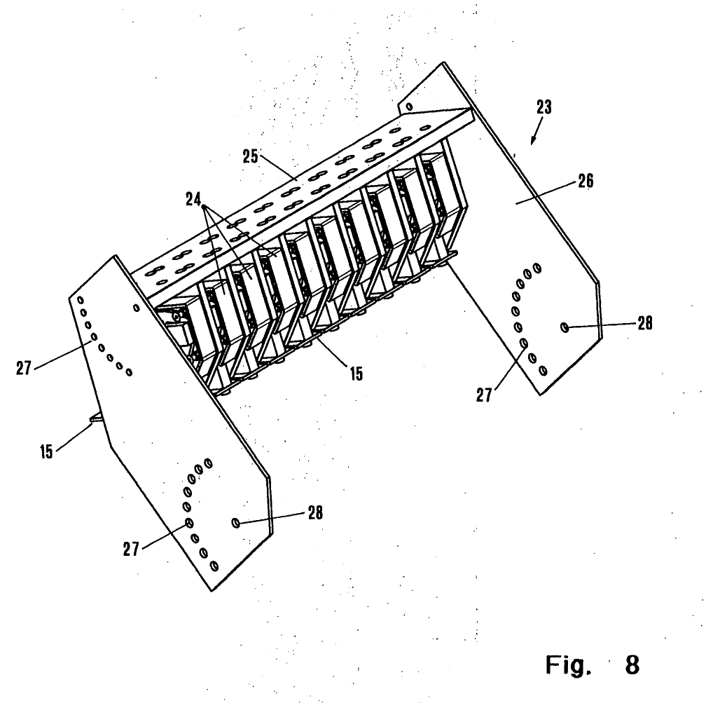

FIG. 1 is a schematic side view of a sorting device with a conveyor belt at the outlet-sided end of which the modular unit, as shown in FIGS. 7 and 8, is arranged, two different fractions of materials being sorted into two different containers with said sorting device;

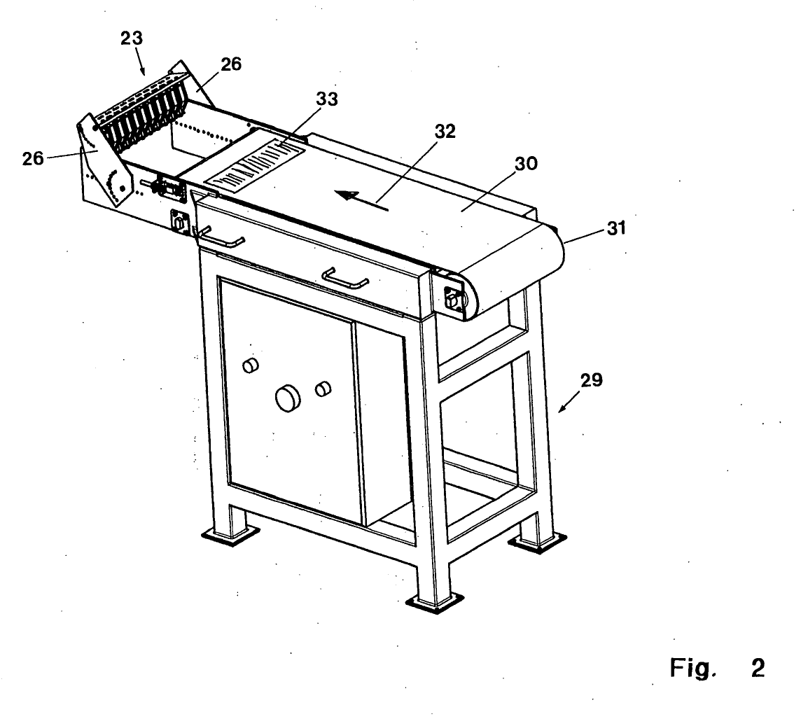

FIG. 2 shows the sorting device of FIG. 1 in a perspective view, arranged on an undercarriage, and with a modular unit modular unit arranged at the outlet-sided end thereof, as shown in FIGS. 7 and 8;

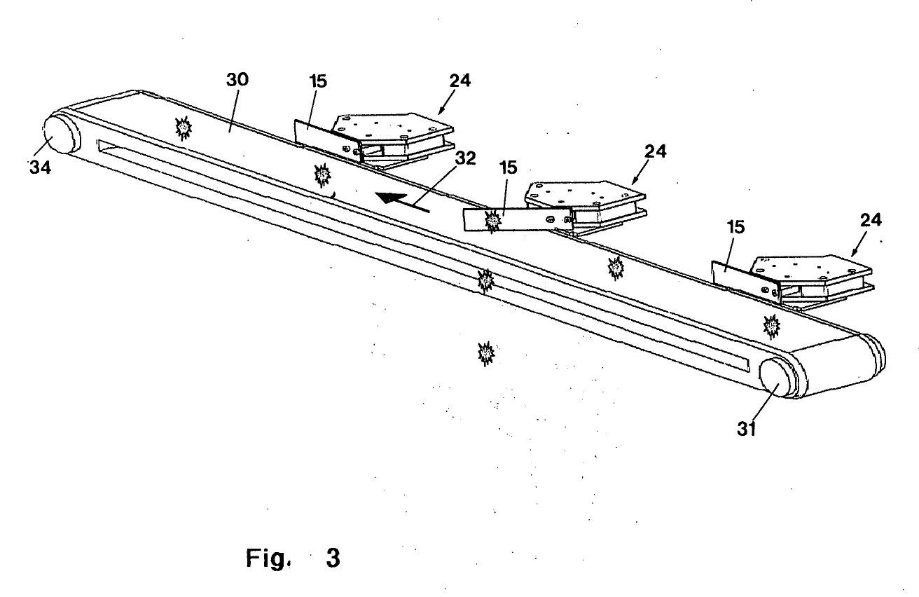

FIG. 3 shows a conveyor belt with three individual actuators arranged at the side of the conveyor belt;

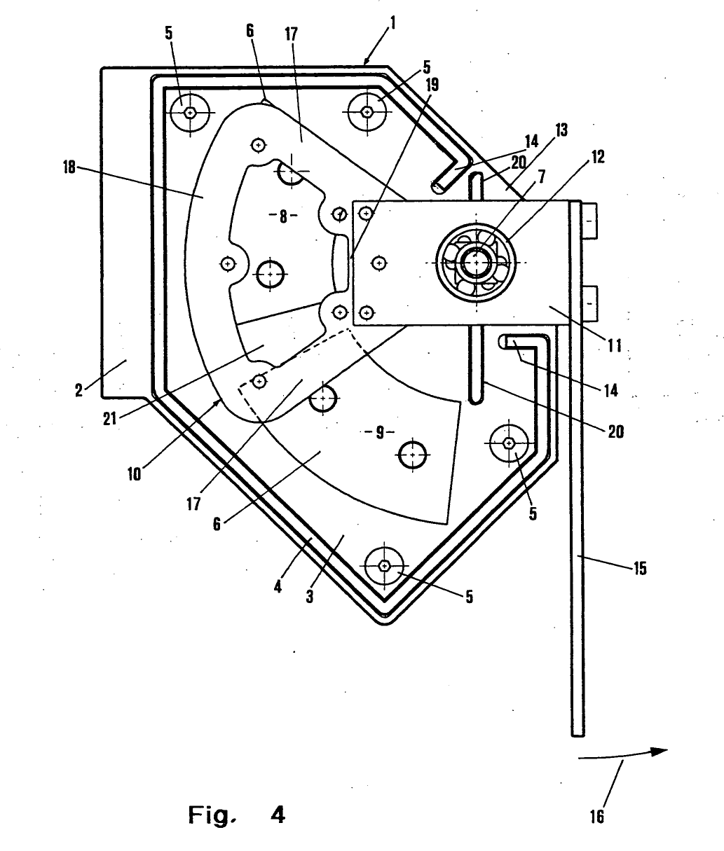

FIG. 4 is a top view on an electromagnetic actuator, as used in the sorting devices of FIGS. 1 and 2, with the housing plate removed, said actuator comprising two pairs of permanent magnets, showing a basic position;

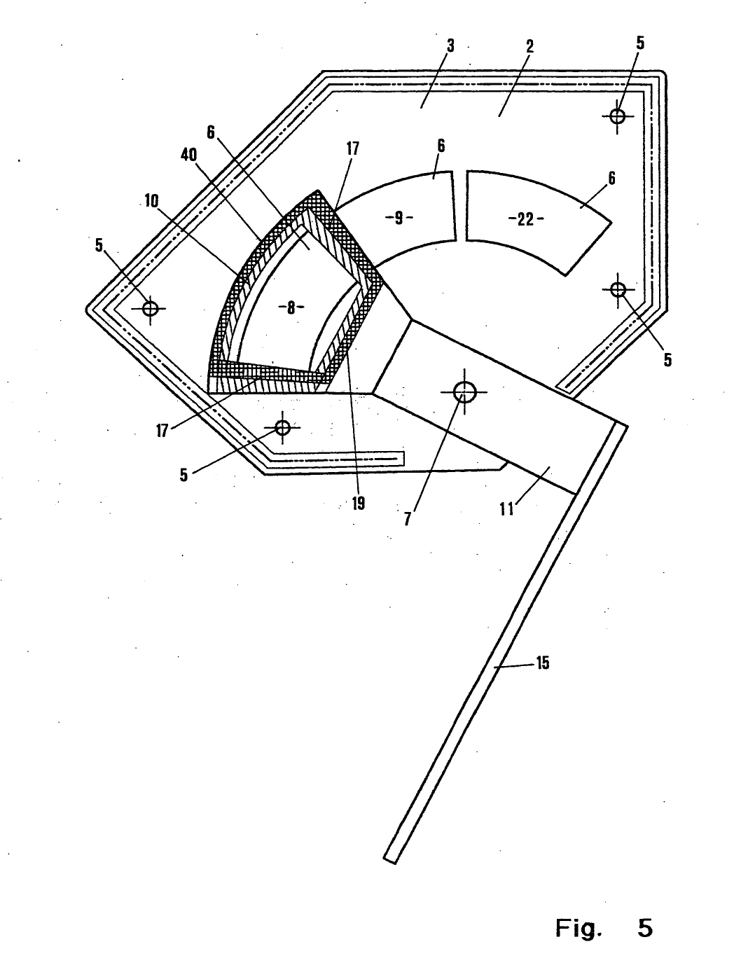

FIG. 5 is a top view on a further electromagnetic actuator, with the housing plate removed, which comprises three pairs of permanent magnets and two coils, showing a basic position;

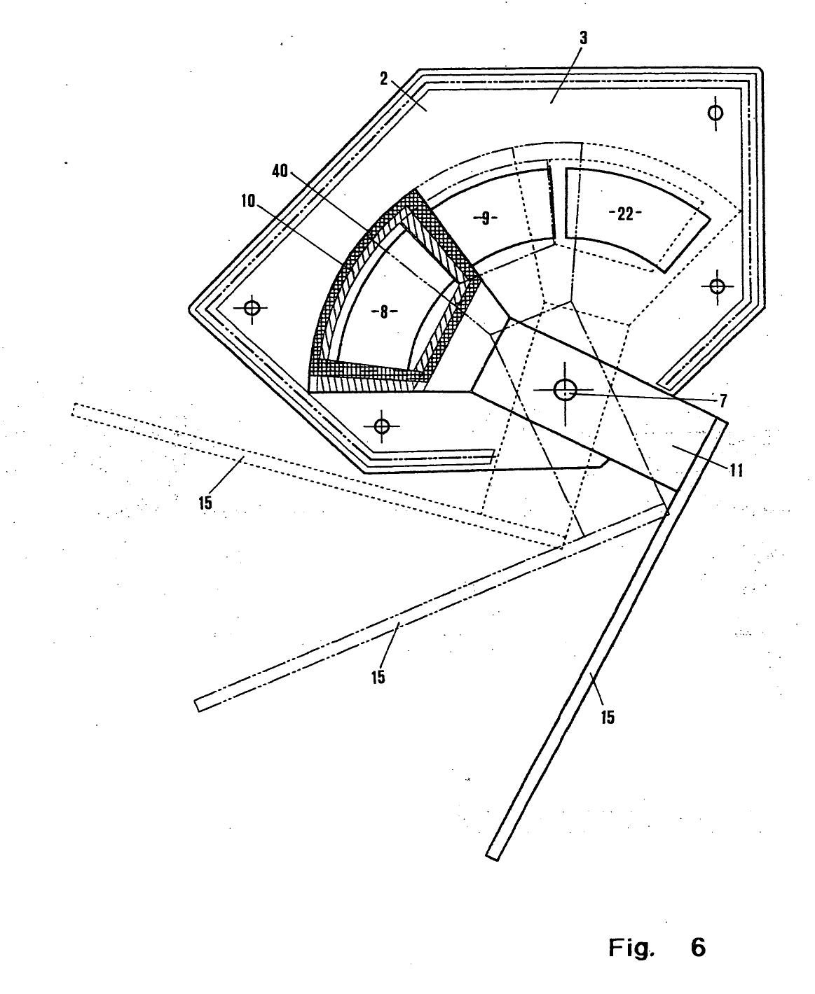

FIG. 6 shows the electromagnetic actuator of FIG. 5, two further positions being illustrated in a dash-dotted line and in an interrupted line;

FIG. 7 shows a modular unit with ten electromagnetic actuators arranged side by side, as shown in FIGS. 4 to 6; and

FIG. 8 shows the modular unit of FIG. 7, without the lateral holding plates, so that it is possible to view the interior of the foremost modular unit.

First of all, an electromagnetic actuator will be described, as used in sorting devices shown in FIGS. 6 to 8; these shall be described in detail hereinafter.

The electromagnetic actuator, as shown in a first embodiment in FIG. 4, comprises a housing structure 1 with two base plates 2 and a housing wall 4 defining the interior 3. The base plates 2, of which only one is shown, are aligned in parallel with each other. Additional spacers 5 are arranged in the corner portions, in the interior 3, by means of which the two base plates 2 are spaced apart and screwed. The housing wall 4 is embedded in a groove 6 in the two base plates 2.

To permit a view into the interior 3 of the electromagnetic actuator, the upper base plate 2 is removed in the illustration of FIG. 4. The construction of the housing structure 1, consisting of the two base plates 2, the housing wall 4 and the spacers 5, yields a simple, but nevertheless stable, construction. The housing parts are preferably made from aluminum.

Each of the two base plates 2 carries on the inside two permanent magnets 6, which are configured in the manner of plate-like ring segments. These ring segments have an inner radius and an outer radius which has its origin along a shaft 7. On the base plate 2, which cannot be seen in FIG. 2 as it has been removed from the housing structure 1, permanent magnets 6 are also arranged that in their size, form and position correspond to the two permanent magnets 6, as can be seen in FIG. 4. A pair of first permanent magnets 8 and a pair of second permanent magnets 9 are thereby formed. The thickness of the permanent magnets 6 has been chosen such that a gap is left between the respective pairs of permanent magnets 8, 9. In this gap a coil 10 is held by a carrier 11 which is suspended from the shaft 7, supported via a ball bearing 12. While the carrier 11 holds the coil 10 at the side oriented towards the permanent magnets 6, it is extended at the side opposite to the coil 10 in such a manner that it extends through an opening 13 into the housing structure 1. Said opening 13 in the housing structure 1 is defined by a respectively inwardly bent end 14 of the housing wall 4. Hence, the carrier 11 can pivot from a basic position, which is shown in FIG. 4 where the lower bent end 14 of the housing wall 4 forms a stop, i.e. from a first position, to a second position in which the bent end 14 of the housing wall 4 that is the upper one in FIG. 4 also forms a stop to define the pivotal movement. The end of the carrier 11 that projects beyond the housing wall 4 has secured thereto a plate 15 which is pivoted by pivoting the carrier 11 together with the coil 10 from the basic position, which is shown in FIG. 4, to an operative position in the direction of the pivot arrow 16.

The coil, as can be seen in FIG. 4, comprises two legs 17 that extend radially relative to the shaft 7 from which the carrier 11 is suspended. A third section 18 of the coil 10 extends in the form of a circular arc and is approximately adapted to the outer radius of the permanent magnets 6, but in a projection onto the permanent magnets 6 it is positioned outside the outer radius of the permanent magnets. A fourth section 19 of the coil 10 is positioned outside the inner radius of the permanent magnets 6.

The windings of the coil 10, which cannot be seen in more detail, extend substantially in a direction perpendicular to the shaft 7, i.e. in parallel with the plane of drawing of FIG. 4. The coil 10 is supplied with current via two stranded wires 20. These stranded wires 20 are silicone-coated wires which turn out to be very flexible and durable. These stranded wires 20 are laid in a loop, as can be seen, the one end being connected to the coil 10, whereas the respective other end forms the power supply at the housing side. The length of the loop of the stranded wires 20 has been chosen such that it is ensured that the respective contact points at the side of the coil 10 and at the housing side are not significantly bent.

The permanent magnets 6 of the pair of first permanent magnets 8 have a magnetic field extending opposite to the magnetic field of the pair of second permanent magnets 9. This means also that the two permanent magnets 6 that are secured to the base plate 2 in FIG. 4 are of opposite polarity. It should also be noted that a space, designated by reference numeral 21, has been left between the two permanent magnets 6 and between the pair of first permanent magnets 8 and the pair of second permanent magnets 9. To illustrate this situation, the invisible portions of the permanent magnets 6 are shown in an interrupted line.

To actuate the electromagnetic actuator, the coil 10, which is negatively biased in the basic position shown in FIG. 4, is acted upon with a positive current pulse, whereby due to the differently oriented magnetic fields of the pairs of first and second permanent magnets 8, 9 it performs a movement from the pair of first permanent magnets 8 to the pair of second permanent magnets 9. Due to this movement the carrier 11 is pivoted together with the plate 15 held thereon, so that the plate 15 is inclined. To return the electromagnetic actuator and the plate 15, respectively, into the basic position, the polarity of the current supplied to the coil 10 is reversed, so that, due to the reversed current direction in the coil, it is again returned into the basic position shown in FIG. 4.

The following should be noted with respect to the electrical supply of the actuator, as shown in FIG. 4. These remarks are also applicable to the other embodiments as shown in the figures described hereinafter. The coil is preferably negatively biased in the basic position, i.e. between the pair of first permanent magnets 8. Switching off the negative voltage and simultaneous switching on of the positive voltage causes a rotational movement to the end position that is as fast as possible (if two pairs of permanent magnets are used). A return movement is again accomplished by switching from positive to negative voltage. Due to the power action over time, the coil can be subjected to considerably greater loads for a short period of time, for example when the actuator is used for a sorting process. There are no resilient counterforces. In connection with the great drive forces, the small moved mass of the actuator, the absence of resilient counterforces and the increase in the spring coil current for a short period of time, a very rapid change in the position of the plate 15 is accomplished.

FIG. 5 shows a second embodiment of an electromagnetic actuator, wherein in contrast to the embodiment of FIG. 4 it is only the base plate 2 that is shown with a carrier 11 which is pivotably held on the shaft 7, and a coil 10 secured to the carrier 11. In contrast to the embodiment shown in FIG. 4, three pairs of permanent magnets 8, 9 and 22 are arranged on the base plate 2 in the embodiment of FIG. 5, the individual permanent magnets 6, configured as circular segment parts, being positioned such that a space 21 is left each time. Furthermore, apart from the coil 10, as is also used in the first embodiment of FIG. 4, a further coil 40 is provided. The coil 10 (shown hatched) and the coil 40 (shown double-hatched) are both held on the carrier 11 and adapted in their size to the size of the permanent magnets 6. Due to the small dimensions of the permanent magnets 6 they have smaller external dimensions than the coil 10 in the embodiment of FIG. 4. As can be seen in FIG. 4, the first coil 10 is offset relative to the second coil 40. The two respective legs 17 of both coil 10 and coil 40 are spaced apart such that in the basic position of the electromagnetic actuator, which is shown in FIG. 5, it is substantially positioned only in the space of the pair of first permanent magnets 8. For actuating the electromagnetic actuator, and starting from the basic position shown in FIG. 5, where the coil 10 is positioned in the gap between the pair of first permanent magnets 8, in which the coil is biased with a negative current, it is supplied upon with a positive current, so that it pivots into the gap between the pair of second permanent magnets 9. This second position is shown in FIG. 6 with the double-dotted line of the carrier 11 and the plate 15. After application of a further pulse, with a reverse sign with respect to the preceding pulse, to the second coil 40 and not to the first coil 10 (which is de-energized), the carrier 11 is moved into a third position between the pair of third permanent magnets 22, resulting in the position of the plate 15 as illustrated in an interrupted line in FIG. 6. Hence, this movement is accomplished in that due to the offset position of the second coil 40 the left leg of the coil 40 is positioned further towards the pair of third permanent magnets 22. Although this is not illustrated in FIGS. 2 and 3, the two coils 10 and 40 are each connected to a pair of stranded wires for separate power supply.

As illustrated by way of FIG. 6, the three different positions can be exploited for different functions or different operating and actuating processes. The electromagnetic actuator, as shown in FIG. 4 to FIG. 6, is designed to deflect parts impinging onto the plate 15 into different directions, as shall be explained hereinafter with reference to the sorting device shown in FIGS. 6 and 7.

The electromagnetic actuator of FIG. 7, with the two different positions of the plate 15, is designed on account of the size of the coil and the size of the sector-like permanent magnets 6 in such a manner that the plate 15 is pivoted by an angle of about 120°.

In the embodiment, as shown in FIGS. 5 and 6, the plate 15 is also pivotable over a range of about 120°, but with three different positions, i.e. a basic position, a position in which the plate 15 is pivoted by 60°, and a third position where the plate 15 is pivoted to the basic position by 120° and with respect to the second position by 60°.

In the illustrations of FIGS. 5 and 6, parts like the stranded wires 20 of the embodiment of FIG. 4 have been omitted for the sake of better clarity.

To keep the electromagnetic actuator small, i.e. with respect to the dimension in the direction of shaft 7, the following dimensions may be provided:

Thickness of the permanent magnets: preferably about 5 mm (minimum thickness 2 mm)

Gap between the respective permanent magnet pairs: 5 mm

Thickness of the coil: preferably about 5 mm (minimum thickness 3 mm)

Thickness of the base plates 2: preferably about 8 mm (minimum thickness 4 mm)

This yields an overall thickness of the housing structure 1, and thus of the electromagnetic actuator, of about 24 mm (with the minimum dimensions 17 mm).

It should be noted that FIGS. 4 to 6 show the electromagnetic actuators approximately true to scale.

FIG. 7 shows a modular unit 23 composed of ten electromagnetic actuators, designated by reference numeral 24. These individual actuators 24 are aligned with one another with the shaft 7 on which the carriers 11 are held. The actuators 24 as used in the modular unit 23 are actuators that comprise two pairs of permanent magnets 8, 9 in the interior 3 of the respective housing structure 1. Unlike the embodiment of FIG. 7, these permanent magnets are not configured as circular segment parts, but these are bar magnets. This is to illustrate that such bar magnets are also possible, though this embodiment does not optimize the conditions.

Each of the actuators 24 of the modular unit 23 comprises a plate 15. These plates can be operated independently of one another by driving the respective actuator 24 (i.e. in a location-dependent manner in y-direction (see the indicated coordinate arrows in FIG. 7)).

A modular unit 23, as shown in FIG. 7, may comprise holding plates 26 mounted at both sides on an upper carrier plate 25 from which the individual actuators 24 are suspended. For pivoting and adjusting the modular unit 23, rows 27 of circular holes are arranged around respective fastening holes 28.

The modular unit of FIG. 8 with the two holding plates 26 is designed for use in connection with a sorting device for sorting different recyclable materials. Such a sorting device is schematically shown in a side view in FIG. 1 and in a perspective view in FIG. 2. FIG. 2 is meant to illustrate the basic operative principle of such a sorting device.

The sorting device of FIG. 1 comprises a conveyor belt 30 which is oriented in horizontal direction. In the sorting device as is shown in a perspective view in FIG. 2, this conveyor belt 30 is held on a basic frame 29. The conveyor belt 30 is guided over a pulley 31 at the input side and over two rear pulleys 34, 35 at the output side, which cannot be seen in FIG. 2. The running direction is marked with a directional arrow 32. The directional arrow 32 corresponds to the direction vector “x” in FIG. 7, but with reverse direction.

At the output side of conveyor belt 30 an individual actuator 24 is positioned in FIG. 1, whereas in the sorting device of FIG. 2 a modular unit 23 is provided. For sorting metal parts, for which purpose this sorting device is particularly suited, metal parts are spread onto the conveyor belt 30 from a reservoir 36. A specific fraction, for instance a specific type of metal, is to be sorted out from these metal parts, this type being marked by black parts in the figure, whereas the remaining metal parts are marked as white parts. These parts are conveyed towards the actuator 24. At the output side of the conveyor belt 30, underneath the belt 30, a sensor 37 is arranged, for example in the form of an inductively operating element. In contrast to the individual sensor 37 in FIG. 6, a sensor field is provided in the arrangement of FIG. 1, the sensor field being identified by field 33. This sensor field 33 consists of a plurality of individual sensors 37 distributed in y-direction, which sense individual metal parts guided on the conveyor belt in a location-dependent manner, in y-direction.

When sensing a black part, the sensor 37 of FIG. 1 produces a signal, whereupon the plate 15 of the actuator 24 is pivoted into the position marked with the black line, so that the black part leaving the conveyor belt 30 impinges on the plate 15 and is deflected into a first collecting container 38. If the sensor 37 senses white parts on the conveyor belt, for example in that no sensor signal is output, the plate 15 is pivoted into the position shown in interrupted line, so that the white parts fall into the second collecting container 39 due to their flight path.

The above-explained principle is employed in the sorting device shown in FIG. 2, which comprises the sensor field 33. The individual sensors of the sensor field 33 produce signals in a location-dependent manner due to specific parts, for example metal parts passing the sensor, and on the basis of such a signal the electromagnetic actuator 24 of the modular unit 23 which is assigned to the position is driven. Due to the operation of the respective actuator 24, the plate 15 thereof is pivoted into the flight path of the corresponding metal part, so that due to the plate 15 the flight path of the metal part impinging on the plate 15 is then changed to sort out the part as a fraction to be sorted. At the output side of the conveyor belt 30, i.e. between the pulley at the output side and the modular unit 23, corresponding collecting hoppers may be positioned.

This yields a sorting device which has a compact construction and, due to the use of the modular unit 23 with the individual electromagnetic actuators, does not need the standard compressed-air nozzles for sorting out the metal parts, nor the associated compressed-air supply means. The specifically used actuators 24, as are also described with reference to FIGS. 4 to 6, are particularly well suited for the purpose of such sorting devices because they provide a more accurate separation and a greater volume flow because of the above-mentioned advantages.

FIG. 3 shows an embodiment with a conveyor belt 30 which is comparable with the conveyor belt 30 of FIGS. 1 and 2. In contrast to the embodiments shown in FIGS. 1 and 2, three actuators 24 spaced apart from one another are positioned in the embodiment of FIG. 3 at the side of the conveyor belt 30. The actuators 24 are oriented such that the plate 15 thereof can be pivoted in horizontal direction, i.e. parallel to the plane of the conveyor belt 30 and in a direction opposite to the running direction of the conveyor belt 30. Upon a sensor signal (the sensors are not shown in FIG. 3) a corresponding actuator 24 is operated to pivot the plate thereof into the transportation path, thereby removing the sensed piece of material from the conveyor belt laterally, i.e. opposite to the actuator 24, e.g. into a corresponding collecting container. The principle of the sorting device, as shown in FIG. 3, can thus be adapted to the respective sorting requirements by way of a greater or smaller number of electromagnetic actuators 24.

What is claimed is:

1. A In a device for sorting different materials, comprising a conveyor belt and at least one sensor which is assigned to the conveyor belt and senses pieces of material in a location-dependent manner on the conveyor belt, and at least one actuator which sorts out pieces of material in accordance with signals of the at least one sensor in a location-dependent manner, the improvement comprising at least one electromagnetic actuator having at least one energizable coil rotatably suspended about a shaft said coil starting from a basic position, performing a rotational movement about the shaft in a gap between a pair of first oppositely magnetized permanent magnets to a second position in a gap between a pair of second oppositely magnetized permanent magnets a magnetic field in the gap of the second permanent magnets extending opposite in direction to a magnetic field in the gap of the first permanent magnets, the rotational movement of the coil effecting an actuating operation for sorting out a piece of material.

2. The sorting device according to claim 1, wherein the at least one electromagnetic actuator is arranged at a side of the conveyor belt.

3. The sorting device according to claim 1, wherein the at least one electromagnetic actuator is driven in a location-dependent manner so as to pivot an ejector connected to the actuator into the transport path of a respective sensed piece of material for sorting out the piece of material.

4. The sorting device according to claim 3, wherein the at least one electromagnetic actuator is arranged at the end of the conveyor belt at an outlet side, and wherein the ejector is pivotable into the transport path of the respective sensed piece of material.

5. The sorting device according to claim 1, wherein windings of the coil extend in planes which are positioned substantially perpendicular to the shaft.

6. The sorting device according to claim 1, wherein the permanent magnets are made from neodymium-iron boron.

7. The sorting device according to claim 1, wherein the permanent magnets are formed as plate-like ring segments.

8. The sorting device according to claim 7, wherein an inner radius and an outer radius of the ring segments have their origin at the shaft.

9. The sorting device according to claim 5, wherein the coil comprises two legs which are radially oriented relative to the shaft.

10. The sorting device according to claim 1, wherein the coil is held on a carrier which is suspended from the shaft, the end of the carrier opposite to the coil forming an ejecting member.

11. The sorting device according to claim 1, wherein each of the permanent magnet pairs are held at one side and at an opposite side of the gap, respectively, on a base plate, the base plates of the magnet pairs forming parts of an exterior housing structure.

12. The sorting device according to claim 11, wherein a bearing in which the shaft is mounted is provided in each base plate.

13. The sorting device according to claim 11, wherein the coil is supplied with current by means of silicone-coated stranded wires.

14. The sorting device according to claim 12, wherein a respective stranded wire is arranged at each side of the carrier and connected to the housing structure.

15. The sorting device according to claim 11, wherein the base plates are spaced apart by a housing wall enclosing the coil and the permanent magnets.

16. The sorting device according to claim 1, wherein at least one further pair of third oppositely magnetized permanent magnets is provided of opposite pole to the pair of second permanent magnets, with a gap thereinbetween, and a further coil is provided, said further coil being offset relative to the first coil such that it is positioned closer to the pair of third permanent magnets and is energized whenever a rotational movement takes place from the pair of second permanent magnets to the pair of third permanent magnets.

17. The sorting device according to claim 16, wherein the position of the coils between the respective pairs of permanent magnets is used for an actuating operation.

18. The sorting device according to claim 1, wherein the first and second pairs of permanent magnets extend over a sector of about 90°.

19. The sorting device according to claim 16, wherein the three pairs of permanent magnets extend over a sector of between 120° and 180°.

20. The sorting device according to claim 1, wherein in the basic position the coil is energized by a voltage of a given polarity and the polarity thereof is reversed for movement from the basic position into the second position.

21. The sorting device according to claim 20, wherein the coil is energized for a return movement from the second position into the first position.

22. The sorting device according to claim 13, wherein the electromagnetic actuator is arranged in a housing, and wherein the respective stranded wire is arranged in a loop having a length several times the direct connection path between a connection point at the coil and a connection point at the housing.

23. The sorting device according to claim 1, wherein a plurality of electromagnetic actuators are arranged side by side, forming a modular unit.

24. The sorting device according to claim 23, wherein the shafts of the individual electromagnetic actuators from which the coils are suspended are positioned along a straight line.

25. The sorting device according to claim 4, wherein the at least one sensor senses pieces of material in a location-dependent manner on the conveyor belt and, in accordance with signals of the sensor corresponding actuators of a modular unit arranged behind the end of the conveyor belt at the outlet side are driven in a location-dependent manner to pivot an ejector connected to the respective actuator into the transport path of the respective sensed piece of material.

26. (canceled)

27. A method of sorting different materials using a comprising a conveyor having a conveyor belt comprising at least one sensor which is assigned to the conveyor belt and senses pieces of material in a location-dependent manner on the conveyor belt, and at least one actuator which sorts out pieces of material in accordance with signals of the at least one sensor in a location-dependent manner, said method comprising the steps of:
(a) placing metal parts on the conveyor belt;
(b) sensing the presence and position of said metal parts;
(c) conveying the metal parts to at least one electromagnetic actuator having at least one energizable coil rotatably suspended about a shaft said coil starting from a basic position, performing a rotational movement about the shaft in a gap between a pair of first oppositely magnetized permanent magnets to a second position in a gap between a pair of second oppositely magnetized permanent magnets, a magnetic field in the gap of the second permanent magnets extending opposite in direction to a magnetic field in the gap of the first permanent magnets, the rotational movement of the coil effecting an actuating operation for sorting out the metal parts; and
(d) energising the at least one electromagnetic actuator to remove selected ones of the metal parts.
